(19) United States
(12) Patent Application Publication
(10) Pub. No.: US 2017/0076396 A1
(43) Pub. Date: Mar. 16, 2017

(54) MONITORING SYSTEM AND METHOD

(71) Applicant: Menachem Sudak, Stanmore, Middlesex (GB)

(72) Inventor: Menachem Sudak, Stanmore, Middlesex (GB)

(21) Appl. No.: 15/123,167

(22) PCT Filed: Feb. 4, 2015
(86) PCT No.: PCT/GB2015/050304

§ 371 Date: Sep. 1, 2016

(30) Foreign Application Priority Data
Feb. 4, 2014 (GB) 1401873.3
Feb. 4, 2014 (GB) 1401874.1

(51) Int. Cl. G06Q 40/08; G07C 5/08

(52) U.S. Cl. CPC G06Q 40/08; G07C 5/085

(57) ABSTRACT

A monitoring system (1) for determining compliance with one or more vehicle insurance rules. The system (1) includes an internal camera (30) for capturing an image of a driver and a controller (2). The controller (2) includes a journey detection module (22) for detecting an attempt by an individual or driver to initiate a journey, an accelerometer (28) for detecting driver behaviour and/or for detecting an eccentric event such as a collision. The controller (2) may also include or be connected to one or more external cameras (31, 32, 33) and/or other sensors to gather data relevant to driver behaviour. The system (1) is configured to capture an image using the internal camera (30) on or after detection of an attempt to initiate a journey. The system (1) compares the captured image with a database of biometric data using a photo recognition algorithm to determine whether it corresponds to the biometric data of an authorised individual. If the image does not correspond to an authorised individual, the policy holder is notified and requested to authorise the driver. If the driver is authorised, the system (1) monitors driving conditions, compiling a driver profile and associating it with the driver. If an eccentric event, such as a collision, is detected the system (1) notifies one or more of an insurance company, monitoring agency, emergency services and law enforcement agency who take appropriate action.

This invention relates generally to a monitoring system and method. More specifically, although not exclusively, this invention relates to a monitoring system and method for use in connection with the operation of a vehicle.

Modern vehicles are fitted with many devices and sensors that measure several parameters relating to the vehicle, such as functions, performance, location and speed. Telemetry systems are becoming increasingly popular in vehicles for some applications including, for example, the measurement of performance, e.g. in motorsport, and the reduction of insurance premiums.

These systems generally measure driver and/or vehicle performance characteristics using onboard sensors and send measurements to a remote location for processing and/or analysis. In the case of telemetry systems installed for insurance purposes, the data is generally sent to an information centre for evaluation by or under the direction of an insurance company. The insurance company then assesses the risk of that driver having an accident to ensure compliance with predetermined conditions. A person that drives less responsibly is charged a higher premium than one that drives with less calculated risk of claim propensity.

U.S. Pat. No. 5,797,134 discloses a method and system of determining a cost of automobile insurance based upon monitoring, recording and communicating data representative of operator and vehicle driving characteristics. The method involves monitoring a plurality of raw data elements representative of an operating state of the vehicle or an action of the operator, recording selected raw data elements when they are determined to have an identified relationship to safety standards and consolidating the raw data for processing against an insurer profile to identify a surcharge or discount to be applied.

Similarly, EP0700009 discloses a system for evaluating risk in the use of automobiles in which a vehicle carries an electronic data processor linked to a speedometer, accelerometer, internal clock and calendar for checking and recording types of traffic hazard, duration of journey and other data related to safety. The system is also arranged to receive electromagnetic signals from the roadside related e.g. to speed limits, icing conditions and traffic jams, and exchanges data by wireless communication with a service station.

Whilst effective in determining certain risks associated with the driving style of an insured vehicle, these known systems could be improved to enable insurance companies to determine more accurately the risks being insured.

It is therefore a first non-exclusive object of the invention to provide a system and method for determining compliance in which the insured risks associated with a vehicle can be determined more accurately. It is a more general non-exclusive object of the invention to provide an improved system and method for determining compliance, preferably one that is more versatile than known systems and methods.

Accordingly, a first aspect of the invention provides a monitoring system for a vehicle, the system comprising:
a) biometric data detection means on or in or associated with or mounted or mountable to the vehicle for detecting biometric data associated with one or more individuals in the vehicle;
b) memory means on which is stored a database of biometric data associated with one or more authorised individuals; and
c) processor means operatively connected to the biometric data detection means and to the memory means;
   wherein the system is configured or programmed to compare, in use, the detected biometric data with the database of biometric data and to determine whether the detected biometric data corresponds to the biometric data of an authorised individual.

Thus, the invention provides an arrangement in which the identity of the driver and/or one or more passengers may be determined, which enables the system to better characterise any data gathered in relation to the use of the vehicle.

The system may comprise journey detection means, which may be associated with or mounted or mountable to a vehicle. The journey detection means may be configured or suitable for detecting an attempt by an individual or driver to initiate a journey. In embodiments, the system comprises communication means, e.g. for transmitting and/or receiving data and/or for communicating with an authority. The authority may comprise one or more individuals, organisations and/or agencies. In some embodiments, the authority may comprise one or more of a policy holder or registered keeper of the vehicle, an insurance company, monitoring agency, emergency services and/or law enforcement authority or any other authority.

The biometric data detection means may be configured or suitable for detecting biometric data associated with an individual operating or driving the vehicle or an individual or driver attempting to initiate the journey.

Advantageously, the system may be configured or programmed to carry out the comparison step on or after detection of an attempt to initiate a journey by the journey detection means. The system may be configured to cause the communication means to alert an authority, for example if the detected biometric data does not correspond to the biometric data of an authorised individual.

Another aspect of the invention provides a monitoring system, e.g. for determining compliance with one or more vehicle insurance rules, the system comprising:
a) journey detection means on or in or associated with or mounted or mountable to a vehicle for detecting an attempt by an individual or driver to initiate a journey;
b) biometric data detection means on or in or associated with or mounted or mountable to the vehicle for detecting biometric data associated with the individual or driver attempting to initiate the journey;
c) memory means on which is stored a database of biometric data associated with one or more authorised individuals;
d) communication means, e.g. for transmitting and/or receiving data and/or for communicating with an authority; and
e) processor means, e.g. a processor, operatively connected to the journey detection means, the biometric data detection means, the memory means and the communication means;
   wherein the system is configured or programmed to compare, e.g. on or after detection of an attempt to initiate a journey by the journey detection means, the detected biometric data with the database of biometric data and to cause the communication means to alert an authority if the detected biometric data does not correspond to the biometric data of an authorised individual.

By configuring the system to alert the authority when the driver is not recognised, unauthorised use of the vehicle may be tracked and, in some cases, prevented. Where the authority is a policy holder or registered keeper of the vehicle, he or she may have a greater awareness of the use of their vehicle and/or approval may be sought. Where the authority is an insurance company or monitoring agency, use of the vehicle may be compared with policy coverage and/or predefined risks, with premiums and/or insurance coverage being adjusted based on such use.

The communication means may comprise a communication element or module or component or device and/or may include a wireless communication or telecommunication means or system or a transmitter or wireless transmitter or receiver or a wireless receiver. The system or communication means may be configured or programmed to transmit data to the authority, for example a message that may comprise data including text and/or voice data and/or image data, e.g. an email, text message, SMS or automated voice message.

The system may be configured or programmed to authorise the journey if the detected biometric data corresponds to the biometric data of one of the authorised individuals. The authority may comprise a policy holder or registered keeper of the vehicle. Additionally or alternatively, the authority may comprise an insurance company or monitoring agency, which may comprise a monitoring agency of the insurance company. The system may be configured or programmed to request authorisation from the authority if the detected biometric data does not correspond to the biometric data of one of the authorised individuals. The system may be configured to determine that the detected biometric data does not correspond to the biometric data of one of the authorised individuals if the data captured is of insufficient quality or does not include sufficient data points to match the detected biometric data to one of the authorised individuals. The alert or request may comprise sending a message that may comprise data including text and/or voice data and/or image data, e.g. an email, text message, SMS or automated voice message. Preferably, the alert or request comprises sending image data, which may include an image of the individual or driver attempting to initiate the journey. The request may comprise sending additional data, such as geospatial position data.

The system may be configured or programmed to authorise the journey when or if an authorisation, for example an authorising message, is received, e.g. by the communication means. The authorisation message may comprise data including text and/or voice data and/or image data, e.g. an email, text message, SMS or automated voice message. The system may be configured or programmed to authorise the journey if, e.g. only if, the authorisation is received from the authority. Receipt from the authority may comprise receiving the authorisation from a communication or telecommunication means or device or system or station having a predetermined identity or telephone number or receiving an authorisation including a passcode or predetermined encryption. Additionally or alternatively, the system may be configured or programmed to analyse a received message and/or to compare a message received by the communication means with an authorisation profile that may be stored on the or a further memory means, e.g. to authenticate the message or to determine whether the message comprises an authorisation from the authority. The further memory means may comprise an authorisation memory means. Where the authorisation comprises a voice message, the system may comprise a voice recognition algorithm, for example wherein the system is configured or programmed to analyse and/or compare the received authorisation, e.g. to a voice message or profile stored on the memory means or the authorisation memory means.

The database or a further database, which may be stored on the memory means, may comprise biometric data relating to one or more unauthorised individuals. The system may be configured or programmed to alert the or a further authority if authorisation is not received, e.g. within a predetermined time period. The alert may be sent via the vehicle communication means and/or may comprise sending a message that may comprise data including text and/or voice data and/or image data, e.g. an email, text message, SMS or automated voice message. The further authority may comprise one or more of a policy holder or registered keeper of the vehicle, an insurance company, monitoring agency, emergency services and/or law enforcement authority or any other authority. In some embodiments, the authority comprises one or more of a policy holder, a registered keeper of the vehicle, an insurance company and a monitoring agency, while the further authority comprises a law enforcement agency or organisation, such as the police.

In embodiments where no authorisation is sought from the authority or policy holder or registered keeper, an alert may be sent to one or more of the policy holder or registered keeper, insurance company, monitoring agency, and/or a law enforcement agency or organisation, such as the police. Thus, the system may be used in conjunction with a conventional vehicle insurance model, e.g. passively without the need for authorisation to be sought.

Preferably, the system is configured or programmed to cause the communication means to alert a policy holder or registered keeper if the detected biometric data does not correspond to the biometric data of one of the one or more authorised individuals. More preferably, the system is configured or programmed to alert the policy holder or registered keeper and/or a monitoring and/or law enforcement agency or organisation, such as the police, if authorisation is not received from the policy holder or registered keeper, e.g. within a predetermined time period.

The system may further comprise an alert means for alerting the individual or driver, e.g. of an authorisation status. The system or alert means may be configured to alert the individual or driver if the detected biometric data does not correspond to the biometric data of one of the authorised individuals. The system or alert means may be configured to alert the individual or driver if the detected biometric data corresponds to an unauthorised individual. The system or alert means may be configured to alert the individual or driver if authorisation is not received from the authority or policy holder or registered keeper, e.g. within a predetermined time period. The alert means may comprise an audible or visual or audiovisual alert means or device. The alert means may comprise an alerter or alert element or module or component or device.

Additionally or alternatively, the system may further comprise journey preventing means, e.g. a journey preventer or stopper or disabler. The journey preventing means may be configured to prevent operation of the vehicle if the detected biometric data does not correspond to the biometric data of one of the authorised individuals or if the detected biometric data corresponds to an unauthorised individual. Additionally or alternatively, the journey preventing means may be configured to prevent operation of the vehicle if authorisation is not received from the authority or policy holder or registered keeper, e.g. within a predetermined time period.

The journey detection means may comprise a detector or detection element or module or component or device. The journey detection means may be configured to detect an operational state of an engine of a vehicle to be monitored and/or the movement or non-movement of the vehicle. The journey detection means may comprise circuitry operatively connected one or more sensors or to one or more systems, e.g. onboard systems, of the vehicle. Additionally or alternatively, the journey detection means may comprise a program or a program element, e.g. on the or a further memory means. The further memory means may comprise a journey detection memory means. In some embodiments, the journey detection means is operatively connected to or comprises a sensor, for example a vibration sensor or accelerometer, which may be positioned to detect whether the engine is in operation. Additionally or alternatively, the journey detection means may be operatively connected to a speedometer of the vehicle or may comprise a geospatial positioning means, for detecting movement of the vehicle. Additionally or alternatively, the journey detection means may comprise a sensor such as an infrared sensor or image and/or video capture means or other type of sensor that may be configured to detect movement within the vehicle.

The system may comprise image and/or video capture means, which may comprise an imager or image capture element or module or component or device, e.g. a camera or camera means. As used hereinafter, the term image capture means is used to encompass devices suitable for capturing images and/or video.

The system may comprise condition detection and/or capture means, which may be configured or suitable for detecting and/or capturing and/or storing data, for example storing data on the or a further memory means. The further memory means may comprise a data storage memory means. The data may relate to one or more conditions associated with the driver, vehicle or environment.

The comparison step may comprise identifying an authorised individual corresponding to the detected biometric data. The system may be configured or programmed to associate data captured from the condition detection and/or capture means with the identified authorised individual.

The condition detection and/or capture means may be configured or suitable for detecting driver behaviour and/or capturing data relating to driving condition and/or environmental condition data. The data may relate and/or be relevant to driver behaviour.

A further aspect of the invention provides a monitoring system, e.g. for determining compliance with one or more vehicle insurance rules, the system comprising:
a) biometric data detection means on or in or associated with or mounted or mountable to a vehicle for detecting biometric data associated with one or more individuals in the vehicle, e.g. an individual operating or driving the vehicle;
b) memory means on which is stored a database of biometric data associated with one or more authorised individuals;
c) condition capture means for capturing data relating to driver behaviour; and
d) processor means, e.g. a processor, operatively connected to the biometric data detection means, the memory means and the condition capture means;
   wherein the system is configured or programmed to compare, in use, detected biometric data with the database of biometric data in order to identify an authorised individual corresponding to the detected biometric data, and to associate data from or captured by the condition capture means with the identified authorised individual.

By associating driver behaviour data with the relevant individuals, risks can be assessed more accurately, with premiums and/or insurance coverage being adjusted based on such assessments. We also believe that this system will enable insurance policies to be related to a driver, rather than to a vehicle. Better or more careful drivers can have insurance premiums determined by their driving profiles, rather than being related to the overall use of a vehicle. This would also allow a single driver to drive several vehicles, but be charged according to a single policy.

The system may be configured to store the captured data, e.g. together with one or more details of the identified authorised individual. The data may be stored in a folder allocated to the identified authorised individual. Additionally or alternatively, the system may be configured or programmed or operable to send at least some of the captured data to an authority, e.g. together with data relating to or one or more details of the identified authorised individual. The system may be configured or programmed to cause the communication means to send the aforementioned data to the authority or to a server of the authority. The authority may comprise a monitoring or insurance agency or an emergency services and/or law enforcement authority.

The captured data may comprise acceleration and/or deceleration data, which may be captured by an accelerometer. The captured data may comprise time data, for example corresponding to the time of day and/or length of time of a journey. The captured data may comprise geospatial position data, for example corresponding to the types of routes or roads travelled on and/or distance travelled and/or parking locations. The captured data may comprise image or video data. The image or video data may relate to a surrounding area of the vehicle, e.g. to detect one or more environmental conditions. The image or video data may relate to one or more individuals within the vehicle, e.g. to detect drowsiness or operation of a handheld device such as a telephone or other device. The captured data may comprise speed data, for example captured from the vehicle's speedometer or onboard control unit or from a global positioning means. The captured data may comprise details relating to occupants of the vehicle, for example number of passengers and/or image or video data of such passengers. The captured data relating to occupants of the vehicle may further comprise biometric data relating to one or more passengers, for example to verify that an authorised individual with restrictions, e.g. a learner driver, is accompanied by another authorised individual, e.g. a qualified driver. The captured data may also comprise one or more characteristics or conditions of the vehicle, for example tyre pressure, status of lights and/or indicators, oil level, engine or brake or other warning messages, and the like.

Any one or more of the aforementioned captured data may be combined and/or time synchronised, for example to provide data indicative of a predetermined or pre-identified risk. For example, speed and/or acceleration and/or deceleration data may be linked to one or more of time data and/or geospatial position data and/or image or video data, for example to identify aggressive driving behaviour. Similarly, parking position data may be combined with image or video data of an area surrounding the vehicle, for example to determine whether the vehicle is surrounded by other vehicles in a traffic situation. Parking position data may also be combined with image or video data of one or more occupants of the vehicle, for example to determine whether anyone is present within the vehicle being indicative of a temporary parking instance.

Preferably, the system is configured to compile and/or store and/or send to an authority a driver profile associated with one or more identified authorised individuals. More preferably, the driver profile includes data relating to driver behaviour and/or details of the identified authorised driver. The driver profile may include data captured by the capture means that is relevant to one or more risks, e.g. predetermined or pre-identified risks. The data relating to driver behaviour or the driver profile may be sent to the authority at the end of each journey or at regular, e.g. predetermined, time intervals.

The system may be configured to analyse at least part of one or more driver profiles, e.g. at least some of the data relating to driver behaviour of the one or more driver profiles, against or according to a risk matrix. The risk matrix may comprise a plurality of risk factors each having a predetermined weighting for converting the driver profile to a risk profile or risk value. Preferably, the system is configured or programmed to extract from a driver profile data relating to one or more or each of the risk factors and to select or generate or calculate a risk profile or risk value based on the data.

The system may be configured or programmed to calculate or modify a premium, e.g. an insurance premium, based on the driver profile, for example based on the selected or generated or calculated risk profile or value. The system may be configured to reduce the premium, for example if the selected or generated or calculated risk profile or value is less or lower than a predetermined risk profile or value. The predetermined risk profile or value may be determined based on an earlier or average risk profile or value for the authorised individual to which it relates or to a pool of authorised individuals. This is intended to award safe and/or low risk driving behaviour. The system may further be configured to increase the premium, for example if the selected or generated or calculated risk profile or value is more or higher than the or a further predetermined risk profile or value.

The condition detection and/or capture means may be configured or suitable for detecting an eccentric event and/or capturing data relating an eccentric event.

Another aspect of the invention provides a monitoring system, e.g. for detecting an eccentric event and/or for determining compliance with one or more vehicle insurance rules, the system comprising:
a) biometric data detection means on or in or associated with or mounted or mountable to a vehicle for detecting biometric data associated with one or more individuals in the vehicle, e.g. an individual operating or driving the vehicle;
b) memory means on which is stored a database of biometric data associated with one or more authorised individuals;
c) condition detection means for detecting an eccentric event; and
d) processor means, e.g. a processor, operatively connected to the biometric data detection means, the memory means and the condition detection means;
   wherein the system is configured or programmed to compare, in use, detected biometric data with the database of biometric data in order to identify an authorised individual corresponding to the detected biometric data, and to associate an eccentric event detected by the condition detection means with the identified authorised individual.

Associating a detected eccentric event with the driver enables the system to gather important evidence relating to an incident in order to enable authorities, such as insurance companies and/or law enforcement agencies, to assess accurately the circumstances under which the incident occurred.

The condition detection means may comprise or form part of the condition detection and/or capture means described above. The system may be configured in response to the detection of an eccentric event to associate data captured by the condition capture means with the eccentric event or data relating thereto and with the identified individual. At least some of the associated data may be stored, e.g. in the memory means or the data storage memory means. Additionally or alternatively, at least some of the associated data may be sent to an authority. In such cases, the system may be configured to send the data to both a monitoring or insurance agency and to an emergency services and/or law enforcement authority.

The data relating to the eccentric event may comprise one or more of image and/or video data, geospatial position data, time and/or date data, driver details or information, acceleration and/or deceleration data and any other data relevant to the event.

In some embodiments, the system is configured or programmed to capture and store video data in a volatile memory, e.g. in a circular buffer which may be a circular buffer of the data storage memory means, for example wherein the oldest data is overwritten with newer incoming data, e.g. such that a fixed and/or continuous length of video is stored. The system or condition detection and/or capture means may comprise one or more sensors, which may be configured or adapted to detect an eccentric event such as a collision or impact, and/or may be configured to monitor and/or store data relating to one or more parameters associated with the vehicle. In some embodiments, the system is configured to monitor deployment of airbags and/or comprises an accelerometer and/or may be configured to detect an event, for example an impact event. The system may be configured or programmed to transfer, e.g. on detection of an eccentric event, the data stored in the volatile memory to a non-volatile memory, e.g. of the data storage memory means.

The biometric data detection means may comprise a detector or detection element or module or component or device. The biometric data detection means may comprise one or more devices for detecting biometric data relating to one or more of a facial profile and/or fingerprints and/or DNA and/or retinal patterns and/or any other biometric parameter or feature.

The system or biometric data detection means may further comprise a comparison algorithm, for example a facial or fingerprint or DNA or retinal pattern recognition algorithm. The system may be configured or programmed to compare one or more characteristics of a captured image or video with the database of biometric data, for example using the comparison algorithm. The captured image or video may comprise an image or video of the individual or driver or his or her face or a fingerprint or retinal pattern. In embodiments, the image may comprise only part, e.g. half or more or less, of an individual or face or fingerprint or retinal pattern.

At least part of the image capture means, e.g. a lens thereof, is preferably positioned or positionable to capture one or more images or videos of an interior of the vehicle, e.g. an image of the individual or driver attempting to initiate the journey and/or of one or more passengers within the vehicle. The at least part of the image capture means may be positioned or positionable or located or locatable or mounted or mountable on or adjacent the windscreen or windshield, for example on or in a visor or a rearview mirror housing, or in or adjacent a pillar or side of the windscreen or windshield.

The system may be configured to suppress or omit or mask part of the data relating to one or more passengers, e.g. to preserve the anonymity or privacy of one or more of the passengers. For example, the system may be configured to capture one or more images or videos of passengers with one or more predetermined areas, e.g. one or more facial areas or regions, suppressed or omitted or masked or blurred or blanked.

At least part of the image capture means, e.g. a lens of which, may be positioned or positionable or located or locatable or mounted or mountable to one or more different parts of the vehicle. Preferably, at least part of the image capture means is positioned or positionable to capture one or more images or videos of an area surrounding the vehicle. More preferably, the image capture means comprises two or more image capture devices for capturing images or videos of two or more parts of an area surrounding the vehicle. The at least part of the image capture means may be positioned or positionable or located or locatable or mounted or mountable adjacent or on or to the front and/or rear of the vehicle, e.g. a front and/or a rear bumper or numberplate or grill or tailgate, and/or one side or each or both sides thereof and/or facing outwardly therefrom.

The system may be configured or programmed to capture video data from the or a further image capture means. The video data may comprise or relate to data corresponding to one or more videos or images of the inside of the vehicle and/or of one or more areas surrounding the vehicle.

The image capture means may comprise at least one wide angle lens, for example a so-called fish-eye lens, and/or be configured to communicate wirelessly with the system, e.g. with the processor and/or memory means. Alternatively, the image capture means may be electrically connected to the processor and/or memory means by a cable or wire or other physical means.

The system may further comprise a geospatial positioning means, which need not be comprised in or used by the journey detection means. The geospatial positioning means may comprise a global positioning system (GPS). The geospatial positioning means may comprise a locator or geospatial positioning element or module or component or device or receiver. The geospatial positioning means may comprise one or more, for example two or more, e.g. three or more, preferably four, locators or geospatial or global positioning elements or modules or components or devices or receivers, which may be configured to determine a geospatial position by communicating with and/or obtaining data from one or more satellites. Each of the locators or geospatial or global positioning elements or modules or components or devices or receivers is preferably located in a different location or position, e.g. to improve the accuracy of the determined geospatial position. Additionally or alternatively, the geospatial position means may comprise a cellular communication means or system or transmitter and/or receiver, for example using cell network triangulation.

The system may further comprise a data transfer means or element or module or component or device, for example a port, e.g. a USB or serial port, or a wireless transmitter, e.g. a radio or Bluetooth or Wifi transmitter, for transferring data from at least one of the memory means for review or analysis. Additionally or alternatively, the system may comprise a display for displaying data stored in or on at least one of the memory means.

One or more of the memory means mentioned herein may comprise a memory or memory element or module or component or device. The memory means may include vehicle identity data stored thereon, which may comprise details of the vehicle and/or of its owner or driver. Additionally or alternatively, the system may also comprise a subscriber identity module card, which may comprise details of the vehicle and/or of its owner or driver and/or of an identity and/or telephone number associated therewith. In some embodiments, the vehicle identity data comprises the vehicle registration number and/or the vehicle identification number.

The system may be configured or programmed to store, e.g. on the memory means or the data storage memory means, data relating to one or more detected journeys or attempts to initiate a journey and/or relating to detected biometric data associated with the individual or driver attempting to initiate the journey and/or data relating to the comparison of the detected biometric data with the database of biometric data. The system may be configured or programmed to store, e.g. on the memory means or the data storage memory means, data relating to the authorisation, e.g. by the system and/or by the authority or policy holder or registered keeper, of individuals attempting to initiate the journey and/or relating to the contacting of the authority or policy holder or registered keeper and/or the alerting of the individual or driver or monitoring and/or law enforcement authority and/or relating to the authorisation or prevention of the journey.

The detection and/or capture means may comprise a detector or detection element or module or component or device. The detection and/or capture means may comprise or be operatively connected to the or a further image capture means. The detection and/or capture means may comprise or be operatively connected to the or one or more further locators or geospatial positioning means or devices or systems and/or one or more temperature gauges and/or any other device useful for detecting or capturing such data. Each of the aforementioned means or devices or systems may comprise one or more vehicle sensors or system, e.g. onboard means or device or system of the vehicle, or an independent or separate or separately mounted such means or device or system. Preferably, the system is configured or programmed to store, e.g. on the memory means or data storage memory means, data relating to the one or more detected and/or captured conditions.

In some embodiments, the or a further alert means may be configured or programmed to alert the individual or driver and/or authority or policy holder or registered keeper and/or a monitoring and/or law enforcement agency or organisation if one or more predetermined conditions is or are detected or captured, for example icing conditions and/or conditions that are inconsistent with one or more insurance rules and/or associated with the individual or driver. In one exemplary embodiment, the individual or driver may have one or more restrictions imposed on him or her, for example he or she may not be authorised to drive at night and/or with more than a predetermined number of passengers, wherein the system is configured or programmed to alert the individual or driver and/or authority or policy holder or registered keeper and/or a monitoring and/or law enforcement agency or organisation if one or more such restrictions is or are breached.

The system may be configured or programmed to transmit or transfer data, for example via the communication means, to a server, e.g. a remote server. The data to be transferred may comprise at least some of one or more of vehicle identity data, captured data, journey data, detected biometric data, results of the comparison of the detected biometric data with the database of biometric data, geospatial position data, image data video data and/or time data associated with any of the aforementioned data. More preferably, the system is configured or programmed to cause the communication means to transmit, e.g. on or after detection of an attempted journey or on or after detection of an eccentric event, at least some of the data, for example to the server or remote server.

The system may further comprise a server, e.g. a remote server, which may comprise a server communication means, e.g. for receiving data from the vehicle communication means and/or for sending data to the vehicle communication means. The server communication means may comprise a communication element or module or component or device and/or may include a wireless communication or telecommunication means or system or a transmitter or wireless transmitter or receiver or a wireless receiver. The server may comprise a server processor and/or may be configured to compare at least some of the received data with one or more predetermined rules or conditions, for example one or more vehicle insurance rules or conditions. The server may also be configured to calculate and/or adjust one or more premiums, e.g. insurance premiums, or costs or values based on at least some of the received data and/or based on the comparison of the at least some of the received data with the rules or conditions. The server may further comprise a transaction means or element or module or component or device, e.g. for processing a transaction associated with the data received from the vehicle communication means and/or corresponding to the one or more calculated premiums or costs or values. Additionally or alternatively, one or more transactions may be processed using an independent system, for example wherein the insurance company is able to access data received by and/or stored on the remote server. In some embodiments, the system may be configured or programmed to alert the individual or driver and/or authority of the calculated and/or adjusted one or more premiums, e.g. insurance premiums, or costs or values.

The server may comprise one or more of the memory means, e.g. on which is stored the database of biometric data associated with one or more authorised individuals and/or the captured data and/or the journey data or any of the other aforementioned data. The processor means may comprise the server processor and/or the communication means may comprise the server communication means. For example, the detected biometric data may be sent to the server and/or the comparison of the detected biometric data with the database of biometric data may be performed by the server processor. Similarly, the server may cause the server communication means to alert the authority if the detected biometric data does not correspond to the biometric data of an authorised individual. Additionally or alternatively, the server may send the results of the comparison and/or details of the identified authorised individual to the vehicle communication means.

In some embodiments, the server comprises a first, e.g. private or secure, server memory means and/or a second, e.g. non-private or non-sensitive or open or accessible or less secure or unsecured, server memory means. The server may be configured to store only part of the data, e.g. non-private or non-sensitive or non-personal data, received by the server communication means on the second server memory means. The server may additionally or alternatively be configured to store all or part of the data, e.g. sensitive or personal data and/or non-private or non-sensitive or non-personal data, received by the server communication means on the first server memory means.

The sensitive or personal data may comprise the image data and/or the video data, while the non-private or non-sensitive or personal data may comprise the time data and/or the geospatial position data and/or the condition data, for example. Alternatively, the sensitive or personal data may comprise the image data and/or the video data and/or the time data and/or the geospatial position data and/or the condition data, while the non-private or non-sensitive or personal data may comprise data derived from any of the aforementioned data and/or from the personal data. The derived data may comprise data derived through processing of the received data, e.g. to provide one or more risk indicators and/or breaches of one or more rules or conditions or predetermined values or parameters indicative of the rules or conditions. The system may comprise a security means or protocol or element or component or module or program or sequence for selectively allowing access to the sensitive or personal data, for example by the driver or owner of the vehicle.

In some embodiments, one or more of the journey detection means and/or biometric data detection means and/or condition detection and/or capture means and/or the geospatial positioning means and/or the image capture means and/or the memory means and/or the processor and/or the alert means is or are at least partially contained within or mounted or connected to or associated with or operatively connected or associated with a housing. Additionally or alternatively, one or more of the detection means and/or the geospatial positioning means and/or the image capture means and/or the memory means and/or the processor is or are operatively connected to or at least partially incorporated within the onboard system, e.g. the onboard computer or information or infotainment system, of the vehicle. Additionally or alternatively, one or more of the detection means and/or the geospatial positioning means and/or the image capture means and/or the memory means and/or the processor is or are operatively connected to or at least partially incorporated in a mobile device, such as a tablet computer or a telecommunications device, e.g. a smart phone.

The system may also comprise a panic button configured on activation to notify one or each of the aforementioned authorities. The system may comprise a speaker and/or microphone for communicating with one or more occupants of the vehicle.

The term “operatively connected” as used herein may comprise a wired or wireless connection. One or more features of the system may communicate with one or more other features of the system via a wireless connection, such as Bluetooth or any other suitable means. It is further envisaged that any combination of wired and wireless connections may be useful. For example, where the system comprises more than one image capture means or device or memory means or device or global positioning means or device, one or more such means or devices may be wired while one or more other such means or devices may be connected wirelessly.

Another aspect of the invention provides a method of monitoring the use of a vehicle, the method comprising:
a) detecting biometric data associated with one or more individuals in a vehicle;
b) comparing the detected biometric data with the database of biometric data; and
c) determining whether the detected biometric data corresponds to the biometric data of an authorised individual.

For the avoidance of doubt, any of the features described herein apply equally to any aspect of the invention. Moreover, the method may comprise one or more features or steps corresponding to, or that the skilled person would consider relevant to, any feature of the system described above or any feature relating to the use of such system.

The method may comprise detecting an attempt by an individual or driver to initiate a journey. The method may also comprise detecting biometric data associated with such an individual or driver. The method may comprise comparing the detected biometric data with the database of biometric data to determine whether the individual or driver attempting to initiate the journey is an authorised individual. The method may comprise alerting an authority if the detected biometric data does not correspond to the biometric data of one of the one or more authorised individuals.

Yet another aspect of the invention provides a method of monitoring the use of a vehicle, e.g. monitoring compliance with one or more vehicle insurance rules, the method comprising the steps of:
a) detecting an attempt by an individual or driver to initiate a journey;
b) detecting biometric data associated with the individual or driver attempting to initiate the journey;
c) comparing the detected biometric data with a database of biometric data associated with one or more authorised individuals to determine whether the individual or driver attempting to initiate the journey is an authorised individual; and
d) alerting an authority if the detected biometric data does not correspond to the biometric data of one of the one or more authorised individuals.

The step of detecting an attempt to initiate a journey may be performed automatically and/or using journey detection means. The step of detecting biometric data may be performed automatically and/or using biometric data detection means. The step of comparing the detected biometric data with a database of biometric data may be performed automatically and/or using a processor. The database of biometric data may be stored on a memory means. The alerting step may be performed automatically and/or using communication means. One or more, e.g. each, of the journey detection means and/or the biometric data detection means and/or the memory means and/or the communication means may be operatively connected to the processor and/or associated with or mounted or mountable to the vehicle.

The method may further include the step of authorising the journey if the detected biometric data corresponds to the biometric data of one of the authorised individuals. The method may comprise requesting authorisation from the authority, for example during or before or after the alerting step.

The method may also comprise authorising the journey when or if an authorisation, for example an authorising message, is received from the authority or from a communication or telecommunication means or device or system or station having a predetermined identity or telephone number. The authorising message may comprise data including text and/or voice data and/or image data, e.g. an email, text message, SMS or automated voice message. The method may comprise analysing a received message and/or comparing a message received by the communication means with an authorisation profile that may be stored on the or a further memory means, e.g. to determine whether the message comprises an authorisation from the authority. Where the authorisation comprises a voice message, the method may further comprise recognising, e.g. using a voice recognition algorithm, the voice message, such as by analysing and/or comparing the voice message to a voice message or profile stored on the or a or a further memory means or memory.

The method may further comprise alerting the authority, for example via the vehicle communication means, e.g. by sending a message, if authorisation is not received from the authority, e.g. within a predetermined time period. The message may comprise data including text and/or voice data and/or image data, e.g. an email, text message, SMS or automated voice message. The authority may comprise a policy holder or registered keeper and/or a monitoring and/or law enforcement agency or organisation, such as the police.

Preferably, the method comprises alerting a policy holder or registered keeper if the detected biometric data does not correspond to the biometric data of one of the one or more authorised individuals. More preferably, the method comprises alerting the policy holder or registered keeper and/or a monitoring and/or law enforcement agency or organisation, such as the police, if authorisation is not received from the policy holder or registered keeper, e.g. within a predetermined time period.

For the avoidance of doubt, the step of authorising the journey may simply comprise identifying the journey as an authorised journey and may, but need not, comprise an active step, e.g. through releasing a prevention means that would otherwise prevent the journey.

The method may further comprise preventing the journey or alerting, for example by audible or visual or other means, the individual or driver, e.g. by providing an audible or visual message or alert to the individual or driver, if the detected biometric data does not correspond to the biometric data of one of the authorised individuals or if the detected biometric data corresponds to an unauthorised individual.

The method may comprise identifying an authorised individual corresponding to the detected biometric data. The method may comprise detecting and/or capturing data that may relate to one or more conditions associated with the driver, vehicle or environment. The method may comprise associating data detected and/or captured with the identified authorised individual.

The step of detecting and/or capturing data relating to one or more conditions be performed automatically and/or using condition detection and/or capture means, which may be operatively connected to the processor and/or associated with or mounted or mountable to the vehicle.

The data or one or more conditions may relate to driver behaviour.

A further aspect of the invention provides a method of monitoring the use of a vehicle, e.g. monitoring compliance with one or more vehicle insurance rules, the method comprising the steps of:
a) detecting biometric data associated with one or more individuals in the vehicle, e.g. an individual operating or driving the vehicle;
b) comparing the detected biometric data with the database of biometric data in order to identify an authorised individual corresponding to the detected biometric data;
c) capturing data relating to driver behaviour; and
d) associating the captured data with the identified authorised individual.

The data or one or more conditions may relate to an eccentric event.

Another aspect of the invention provides a method of monitoring the use of a vehicle, e.g. monitoring and/or detecting an eccentric event, the method comprising the steps of:
a) detecting biometric data associated with one or more individuals in the vehicle, e.g. an individual operating or driving the vehicle;
b) comparing the detected biometric data with the database of biometric data in order to identify an authorised individual corresponding to the detected biometric data;
c) detecting an eccentric event; and
d) associating the detected eccentric event with the identified authorised individual.

The method may comprise capturing and storing video data in a volatile memory, e.g. in a circular buffer and/or of the memory means, for example wherein the oldest data is overwritten with newer incoming data, e.g. such that a fixed and/or continuous length of video is stored. The method may also comprise detecting an eccentric event, such as a collision or impact, and/or monitoring and/or storing data relating to one or more parameters associated with the vehicle. In some embodiments, the method comprises monitoring deployment of airbags and/or obtaining measurements from an accelerometer. The method may comprise transferring, e.g. on detection of an eccentric event, the data stored in the volatile memory to a non-volatile memory, e.g. of the memory means.

The step of detecting biometric data may comprise capturing image or video data, for example relating or corresponding to the individual or driver and/or one or more passengers, using image capture means, e.g. internal to the vehicle. The step of comparing the biometric data may comprise the use of one or more facial recognition techniques or algorithms. Additionally or alternatively, the step of detecting biometric data may comprise detecting or capturing biometric data relating to one or more of fingerprints and/or DNA and/or retinal patterns and/or any other biometric parameter or feature.

The may comprise suppressing or omitting or masking part of the data relating to one or more passengers, e.g. to preserve the anonymity or privacy of one or more of the passengers. For example, the method may comprise capturing one or more images or videos of passengers with, or processing them to have, one or more predetermined areas, e.g. one or more facial areas or regions, suppressed or omitted or masked or blurred or blanked. Additionally or alternatively, the method may comprise storing the one or more images or videos with one or more predetermined areas, e.g. one or more facial areas or regions, suppressed or omitted or masked or blurred or blanked.

The method may also comprise capturing one or more, preferably two or more, more preferably a plurality of, images or videos of an area surrounding the vehicle. Additionally or alternatively, the method may comprise capturing video data, e.g. from the or a further image capture means.

The method may comprise storing, e.g. on the or the further or a or a yet further memory means, data relating to one or more detected journeys or attempts to initiate a journey and/or relating to detected biometric data associated with the individual or driver attempting to initiate the journey and/or data relating to the comparison of the detected biometric data with the database of biometric data. Additionally or alternatively, the method may comprise storing, e.g. on the or the further or a or a yet further memory means, data relating to the authorisation, e.g. by the system and/or by the authority or policy holder or registered keeper, of individuals attempting to initiate the journey and/or relating to the contacting of the authority or policy holder or registered keeper and/or the alerting of the individual or driver or monitoring and/or law enforcement authority or agency and/or relating to the authorisation or prevention of the journey.

The method may further comprise detecting and/or capturing data relating to one or more conditions, such as driver conditions, e.g. drowsiness or operation of a handheld device such as a telephone or other device, and/or environmental conditions, e.g. time and/or parking location and/or type or class of road and/or speed and/or external light and/or temperature. The detected or captured data may comprise one or more of image and/or video data and/or geospatial position data and/or accelerometer data and/or any other data relevant for determining one or more risks associated with the use of the vehicle. Preferably, the method further comprises storing, e.g. on the or the further or a or a yet further memory means or memory, data relating to the one or more detected conditions.

In some embodiments, the method comprises alerting the individual or driver and/or authority or policy holder or registered keeper and/or a monitoring and/or law enforcement agency or organisation if one or more predetermined conditions is or are detected or captured, for example icing conditions and/or conditions that are inconsistent with one or more insurance rules and/or associated with the individual or driver. In one exemplary embodiment, the individual or driver may have one or more restrictions imposed on him or her, for example he or she may not be authorised to drive at night and/or with more than a predetermined number of passengers, wherein the method comprises alerting the individual or driver and/or authority or policy holder or registered keeper and/or a monitoring and/or law enforcement agency or organisation if one or more such restrictions is or are breached.

The method may comprise transmitting or transferring data, for example via the communication means, e.g. vehicle identity data and/or at least some of one or more of the journey data and/or condition data and/or detected biometric data and/or the results of the comparison of the detected biometric data with the database of biometric data and/or the geospatial position data and/or the image data and/or the video data and/or time data associated with any of the aforementioned data. More preferably, the method comprises transmitting, e.g. on or after detection of an attempted journey, at least some of the data, for example to a server or remote server, e.g. a communication means thereof.

The method may further comprise comparing at least some of the received data with one or more predetermined rules or conditions, for example one or more vehicle insurance rules or conditions. The method may further comprise calculating and/or adjusting one or more premiums, e.g. insurance premiums, or costs or values based on at least some of the received data and/or based on the comparison of the at least some of the received data with the rules or conditions. The method may further comprise processing a transaction associated with the data received from the vehicle communication means and/or corresponding to the one or more calculated premiums or costs or values. In some embodiments, the method comprises alerting the individual or driver and/or authority of the calculated and/or adjusted one or more premiums, e.g. insurance premiums, or costs or values.

The method may comprise storing all or part of the data, e.g. sensitive or personal data and/or non-private or non-sensitive or non-personal data, received by the server communication means on a first, e.g. private or secure, server memory means. The method may further comprise storing only part of the data, e.g. non-private or non-sensitive or non-personal data, received by the server communication means on a second, e.g. non-private or non-sensitive or open or accessible or less secure or unsecured, server memory means. The sensitive or personal data may comprise the image data and/or the video data, while the non-private or non-sensitive or personal data may comprise the time data and/or the geospatial position data and/or the condition data, for example. Alternatively, the sensitive or personal data may comprise the image data and/or the video data and/or the time data and/or the geospatial position data and/or the condition data, while the non-private or non-sensitive or personal data may comprise data derived from any of the aforementioned data and/or from the personal data. The derived data may comprise data derived through processing of the received data, e.g. to provide one or more risk indicators and/or breaches of one or more rules or conditions or predetermined values or parameters indicative of the rules or conditions. The method may comprise selectively allowing access to the sensitive or personal data, for example to the driver or owner of the vehicle, e.g. using a security means or protocol or element or component or module or program or sequence.

Another aspect of the invention provides a controller configured or programmed to execute the aforementioned method and/or for incorporation into the aforementioned system.

A further aspect of the invention provides a computer program element comprising computer readable program code means for causing a processor to execute a procedure to implement the aforementioned method. A yet further aspect of the invention provides the computer program element embodied on a computer readable medium.

A yet further aspect of the invention provides a computer readable medium having a program stored thereon, where the program is arranged to make a computer execute a procedure to implement the aforementioned method.

Another aspect of the invention provides a vehicle comprising a system as described above and/or a controller as described above and/or a computer readable medium as described above.

Embodiments of the invention will now be described by way of example only with reference to the accompanying drawings in which:

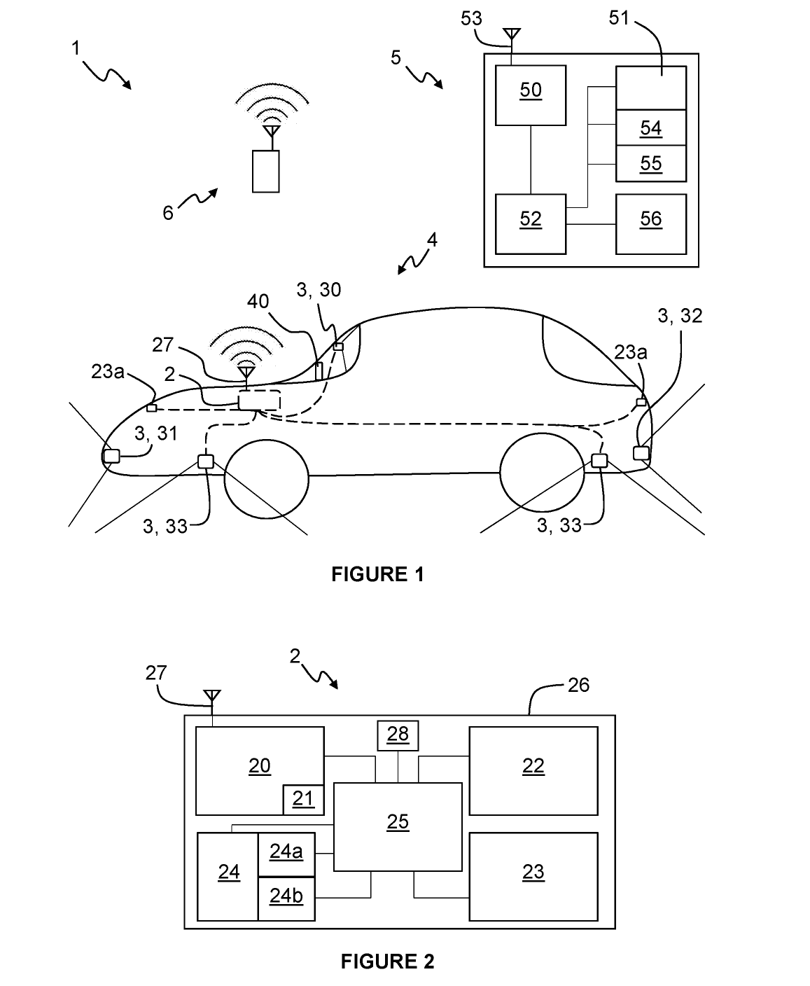

FIG. 1 is a schematic view of a monitoring system according to one embodiment of the invention;

FIG. 2 is a schematic of the control unit of the system of FIG. 1; and

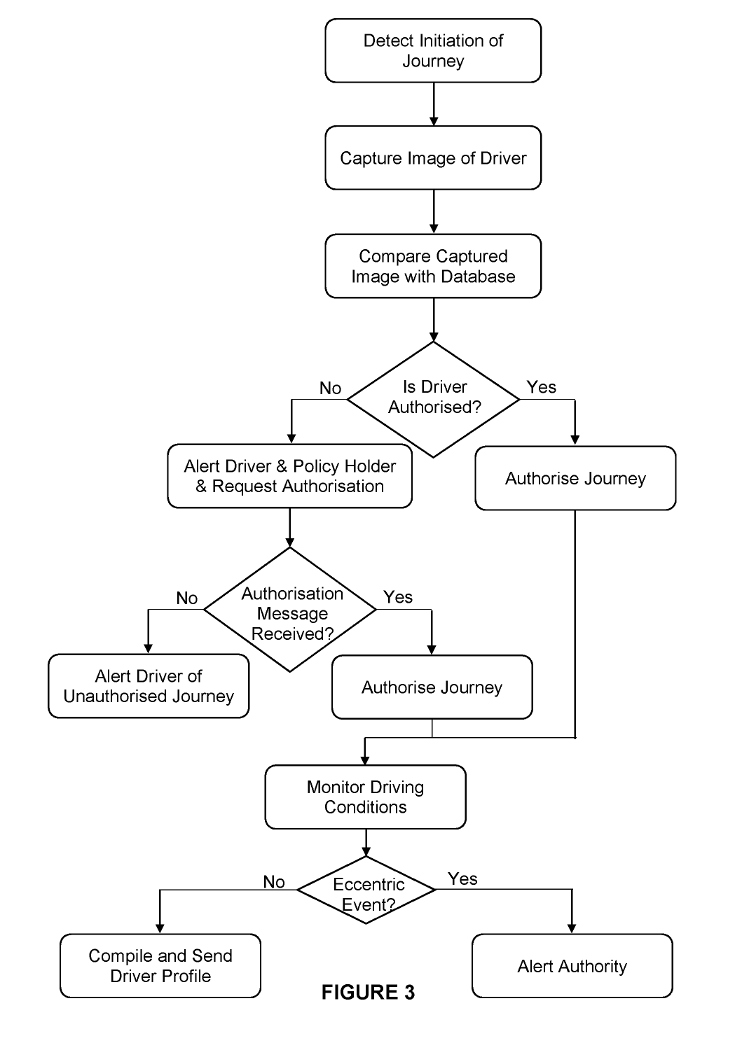

FIG. 3 is a schematic flow diagram illustrating a method according to one embodiment of the invention.

Referring now to FIGS. 1 and 2, there is shown a monitoring system 1 for determining compliance with insurance rules and for detecting a collision. The system 1 includes a control unit 2 and image capture means 3 both associated with or mounted to a vehicle 4, a remote server 5 and a mobile telephone 6 associated with the policy holder.

The control unit 2 in this embodiment includes a telecommunication module 20 with an associated subscriber identity module card 21, a detection module 22, a geospatial positioning module 23, a memory module 24, a processor 25, all of which are contained within a housing 26. The control unit 2 also includes a transmission antenna 27, which is connected to the telecommunication module 20, and an accelerometer 28 for detecting acceleration in three dimensions.

The subscriber identity module card 21 includes identification details for the vehicle, the owner of the vehicle and a telephone number. The detection module 22 is operatively connected to the vehicle's engine management system (not shown), for detecting operation of the engine, and to the image capture means 3, for capturing biometric data relating to a driver (not shown). The geospatial positioning module 23 is operatively connected by cables to four global positioning system (GPS) devices 23a, which are positioned adjacent the four corners of the vehicle in this embodiment. It will be appreciated that one or more of the cables may be replaced by a wireless connection and/or one or more of the GPS devices 23a may be incorporated in other devices or features, for example one of the GPS devices 23a may comprise an onboard vehicle GPS. The memory module 24 includes a first, non-volatile memory 24a and a second, volatile memory 24b. The memory module 24 also stores a database of biometric data relating to authorised drivers of the vehicle 4 and facial recognition software.

Each of the telecommunication module 20, detection module 22, geospatial positioning module 23, memory module 24, first memory 24a and second memory 24b is operatively connected to the processor 25.

The image capture means 3 includes an internal camera 30 a pair of forward facing cameras 31, a pair of rearward facing cameras 32 and four side facing cameras 33 adjacent the four corners of the vehicle 4. In other embodiments, the image capture means may comprise a single camera or a single internal camera 30 and a single or two external cameras 32 and/or 33, e.g. one forward facing and one rearward facing external camera 32, 33. The internal camera 30 is mounted within the housing of the rearview mirror of the vehicle 4 in this embodiment and is configured to capture image and/or video data relating to the driver (not shown) and passengers (not shown). The forward, rear and side facing cameras 31, 32, 33 are each configured to capture image and/or video data of respective areas surrounding the vehicle. Each of the cameras 30, 31, 32, 33 incorporates a wide angled lens and is operatively connected to the control unit 2 by cables in this embodiment, although these cables may be replaced by a wireless connection. In this embodiment, the system 1 is configured to capture and store video data from each camera 30, 31, 32, 33 in the volatile memory 24b in a circular buffer, wherein the oldest data is overwritten with newer incoming data so that a fixed and continuous length of video is stored corresponding to the most recent sixty second rolling period.

The monitoring system 1 is operatively connected to the controller area network (CAN) bus system (not shown) of the vehicle 4 in this embodiment. The vehicle 4 includes an onboard infotainment system 40 and an engine management system (not shown), both of which are operatively connected to the monitoring system 1 for interacting with and presenting information to the driver and/or passengers of the vehicle and for detecting the operation of the engine and/or the ignition.

The remote server 5 includes a telecommunication module 50, a memory module 51, a processor 52, a transmission antenna 53 operatively connected to the telecommunications module 50 for sending and/or receive data. The memory module 51 includes a first, private or secure memory 54 and a second, non-private memory 55. The remote server 5 also includes a transaction module 56 for processing payment transactions relating to insurance premiums. The telecommunication module 50, memory module 51, first memory 54, second memory 55 and the transaction module 56 are all operatively connected to the processor 52.

As illustrated in FIG. 3, the system 1 functions according to the following steps when the driver (not shown) starts the engine of the vehicle 4:
a) the detection module 22 detects the start of the engine (not shown);
b) the internal camera 30 captures an image of the driver (not shown);
c) the processor compares the image of the driver (not shown) with the database of biometric data stored on the memory module 24 using the facial recognition software to determine whether the driver (not shown) attempting to initiate the journey is an authorised individual;
d) if the driver (not shown) is an authorised individual, the journey is authorised;
e) if the driver (not shown) is not an authorised individual or if the image is insufficient quality to make a determination, the system 1 alerts the driver (not shown) via the infotainment system and alerts the policy holder and requests an authorisation message by sending a message including the image of the driver (not shown), and, optionally, GPS data and/or text and/or voice data via the telecommunication module 20 to the mobile telephone 6;
f) if an authorisation message, which is a voice message in this embodiment but can be any other form of message including but not limited to a text based message, is received from the mobile telephone 6 within five minutes, the journey is authorised;
g) if no authorisation voice message is received within five minutes, the system 1 alerts the driver (not shown) via the infotainment system 40 that the journey is not authorised.

If the driver (not shown) chooses to commence the journey, ignoring an alert that the journey is unauthorised, the system 1 alerts a monitoring agency and/or law enforcement agency of the unauthorised journey via the telecommunication module 20. This situation is detected by detecting movement of the vehicle 4 through the geospatial positioning module 23. The alert to the agency may include an image of the driver, the vehicle make, model and registration number and GPS location information.

In this embodiment, authorisation must be received from the mobile telephone 6 and it must be in the form of a voice message from the policy holder for enhanced security. The voice message is analysed using a voice recognition algorithm and compared to a voice profile stored on the memory module 24. If a voice message is received from the mobile telephone 6, but the comparison finds that it does not correspond to the voice profile stored on the memory module 24, the voice message is not considered an authorisation voice message.

Authorisation of the journey in this embodiment involves identifying the journey as an authorised journey. It is also envisaged that the system may be configured to actively prevent the journey. It is further envisaged that instead of a voice message, the authorisation may involve the policy holder or registered keeper of the vehicle selecting electronically from a menu of options either to confirm the driver as authorised or as unauthorised. The policy holder or keeper does not reply, the request for confirmation may be followed up by an automated telephone call requesting the same information.

The system 1 is also configured to store in the memory module 24 data relating to detected journeys. The system 1 is also configured to monitor and store in the memory module 24 data relating to predetermined driving conditions that are indicative of driver and/or vehicle performance, such as data measured by the accelerometer and by the vehicle's onboard systems including vehicle speed, acceleration, deceleration, lateral forces due to cornering and other manoeuvres and other engine performance parameters considered to be relevant to determining one or more risks associated with the driver. The monitored driving conditions may also include data relating to time and/or location, e.g. geospatial position data such as the position in which the vehicle is parked at night and/or roads and/or times during which the vehicle is driven by any particular authorised individual, e.g. a young or high risk individual.

The driving condition data may also include image data relating to internal and/or external images captured by the cameras 30, 31, 32, 33. The internal images may include data relating to one or more passengers (not shown), for example where one of the authorised individuals is restricted from driving with a predetermined number of passengers (not shown). In such cases, the system 1 is configured to suppress the faces of the passengers (not shown) to preserve their anonymity or privacy. Additionally or alternatively, the system may be configured to detect, e.g. via a program or algorithm, driver drowsiness or driver operation of a handheld device such as a telephone or other device from the internal images or from video data obtained from the internal camera 30. The external images may include data relating to one or more environmental conditions, for example lighting conditions of one or more areas surrounding the vehicle. Data relating to other conditions may also be included, as explained above and/or as would be appreciated by those skilled in the art.

The system 1 associates all of the aforementioned data with the authorised individual identified in step c above, or the individual authorised in step f above. This is done at the time the data is stored in the memory module 24. The data may be stored based on each journey and include, for example, the date and time of the start and end of the journey, the locations of the start and end of the journey, the maximum speeds reached, maximum acceleration and deceleration in the driving direction and/or in a lateral direction (indicating aggressive manoeuvring) and/or number of occasions in which such values exceed a predetermined value. The data may also include video data associated with one or more harsh manoeuvres, lighting conditions and any other parameters determined to be indicative of risks. Thus, a driver profile is compiled in respect of each authorised individual.

All of the aforementioned stored data is transmitted together with the vehicle identity data on a regular, e.g. daily, basis to the remote server 5, where it is received by the server telecommunication module 50 and stored in the first, private or secure memory 54 of the memory module 51. On receipt of the data, the server 5 compares the received data with predetermined vehicle insurance rules and calculates insurance premium adjustments for the vehicle identified on the basis of the results of the comparison. The server 5 stores the insurance premium adjustments together with the vehicle identification data on the second, non-private memory 55 of the memory module 51.

The comparison preferably involves analysing the data forming the driver profiles according to a risk matrix. The risk matrix includes a plurality of risk factors each having a predetermined weighting for calculating a risk profile using the driver profile data. The calculated risk profiles for all drivers associated with the policy are then compared with predetermined standard risk profiles and the premiums are adjusted, if appropriate, based on these comparisons. More specifically, the premium is reduced if the risk profiles are less than the predetermined risk profile or is increased if they are higher.

In this embodiment, the server 5 compiles a log of the premium adjustments and reasons for the adjustments associated with each vehicle 4 throughout each calendar month. At the end of the calendar month, the server 5 causes the transaction module 56 to initiate a transaction for the total adjusted insurance premium associated with each vehicle 4. The transactions are processed using the non-private data stored in the second, non-private memory 55 relating to the list of adjustments, while the personal data stored on the first, private or secure memory 54 of the memory module 51 is only accessible by or with the permission of an authorised person, for example the driver or owner of the vehicle 4. As an example, this personal data may be retained for a period of six months.

As explained above, the video data captured from each of the cameras 30, 31, 32, 33 and to store the video data in the second, volatile memory 24b in a circular buffer, wherein the oldest data is overwritten with newer incoming data such that a fixed, continuous length of video is stored.

When an eccentric event, such as a collision, is detected by the accelerometer 28, the video data stored in the volatile memory 24b is transferred to the first, non-volatile memory 24a together with time and GPS data relating to the video data. The system 1 also continues to capture video data from each of the cameras 30, 31, 32, 33 for an additional predetermined period of time, for example one minute, and stores this further data on the first memory 24a.

The video data, along with GPS data, date and time data, driver data and acceleration and deceleration data are transmitted to the server 5 and stored in the first, private or secure memory 54 of the memory module 51. In this embodiment, a monitoring agency is sent a message indicating that a collision has been detected. The monitoring agency contacts the policy holder and/or, if known, a mobile phone associated with the authorised individual identified in step c above to ascertain whether the emergency services and/or a law enforcement authority should be contacted. Based on the feedback received or if the policy holder or authorised individual is not contactable, the monitoring agency then takes appropriate action. Optionally, the monitoring agency may also be given access to the video data associated with the incident and may be authorised or instructed to provide such data to the emergency services and/or law enforcement authority.

It will be appreciated that the invention provides a system that enables insurers to be notified immediately following an incident resulting in a loss likely to be the subject of a claim. Recent legislation in the UK has necessitated rapid first notification of loss (FNOL) to ensure that any claims are dealt with efficiently and effectively. Under the new legislation, the process of claiming has been streamlined by the introduction of fixed timelines for the agreement of liability and the value of any third party injuries.

Emergency services and law enforcement authorities can also be alerted to an incident immediately. Similarly, a breakdown agency may be contacted in the event of breakdown, for example where an eccentric event is detected that relates to a vehicle fault, such as a flat tyre and the like. The system 1 may also be used to provide assistance in locating the vehicle, for example where a driver has forgotten where they have parked or to trace a stolen vehicle, including retrieving image and/or video data of the occupants and/or of the surrounding environment using the cameras 30, 31, 32, 33. The system 1 may also be used for unlocking the doors of the vehicle remotely or checking the status of one or more features or parameters of the vehicle remotely (e.g. fluids, brakes, failed light bulbs and the like). In some embodiments, the system 1 may be configured to instigate a service appointment automatically, for example based on one or more features monitored remotely (e.g. fluids, brakes, failed light bulbs and the like). The system 1 may be configured to log business vs personal use of the vehicle based on one or more criteria, for example time criteria and/or GPS location data and so on. The system 1 may be customised to provide predetermined driver dependent education or incentives and the like.

In some embodiments, the system 1 may be configured to carry out automated checks to ensure its proper operation of one or more features thereof and/or to detect tampering. For example, data may be stored as driving events with time and GPS data associated with other data, wherein successive driving events are compared to ensure continuity. Moreover, operation of the cameras 30, 31, 32, 33 may be checked regularly by monitoring pixel changes, for example during movement of the vehicle. In the event of a fault being detected, the policy holder or registered keeper may be alerted.

The system 1 may include and/or be at least partly incorporated within a bespoke device or housing 26. Alternatively, one or more or all of the features of the system 1 may be incorporated within a mobile telecommunications device, such as a smart phone (not shown) that may include a bespoke software application configured to provide the aforementioned functionality. In some embodiments, one or more or all of the features of the system 1 may be incorporated within one or more numberplates.

It will be appreciated by those skilled in the art that several variations to the aforementioned embodiments are envisaged without departing from the scope of the invention. For example, the system may include a vibration sensor positioned to detect whether the engine is in operation and/or the or a further geospatial positioning means may be configured to detect movement of the vehicle in order to determine the initiation of a journey. The alert need not be provided through the infotainment system 40, e.g. the system 1 may include a standalone display or audible alert device. The system 1 may be configured to monitor deployment of airbags in addition to or as an alternative to the use of an accelerometer 28 for detecting a collision.

Moreover, the geospatial location of the vehicle may be determined using a cellular communication means or system instead of a global positioning system using satellites, for example using cell network triangulation. The biometric data detection may involve detecting or capturing and comparing biometric data relating to one or more of fingerprints and/or DNA and/or retinal patterns and/or any other biometric parameter or feature.

It will also be appreciated that any of the aforementioned periods of time may be altered according to the requirements of any particular application.

It will also be appreciated by those skilled in the art that any number of combinations of the aforementioned features and/or those shown in the appended drawings provide clear advantages over the prior art and are therefore within the scope of the invention described herein.

1-43. (canceled)

44. A monitoring system for determining compliance with one or more vehicle insurance rules, the system comprising:
a journey detection module associated with a vehicle for detecting an attempt by an individual to initiate a journey;
a biometric data detection module associated with the vehicle for detecting biometric data associated with the individual or driver attempting to initiate the journey;
a memory on which is stored a database of biometric data associated with one or more authorized individuals;
a vehicle communication module for communicating with an authority; and
a processor operatively connected to the journey detection module, the biometric data detection module, the memory module and the vehicle communication module;
wherein the system is configured to compare, on or after detection of an attempt to initiate a journey by the journey detection module, biometric data detected by the biometric data detection module with the database of biometric data and to cause the vehicle communication module to alert an authority if the detected biometric data does not correspond to the biometric data of an authorized individual.

45. A monitoring system according to claim 44, wherein the system is configured to cause the vehicle communication module to
request authorization from the authority if the detected biometric data does not correspond to the biometric data of an authorized individual;
compare a message received by the vehicle communication module with an authorization profile stored on the memory to determine whether the message comprises an authorization from the authority; and
authorize the journey if the message is determined to be an authorization from the authority.

46. A monitoring system according to claim 44 further comprising a remote server with a server communication module receiving data from the vehicle communication module and for sending data to the vehicle communication module, wherein the remote server comprises the memory.

47. A monitoring system according to claim 44 further comprising a condition detection sensor operatively connected to the processor for detecting an eccentric event, wherein the system is configured to associate data detected or captured by the one or more condition detection sensors with the identified authorized individual.

48. A monitoring system according to claim 47, wherein the system is configured to cause the vehicle communication module to send a message to an emergency services authority or law enforcement authority on detection of the eccentric event.

49. A monitoring system according to claim 47, wherein the condition detection sensor comprises an accelerometer.

50. A monitoring system according to claim 44 further comprising one or more image capture devices, wherein at least one of the one or more image capture devices is operatively connected to the biometric data detection module and is configured, in use, to capture an image of at least part of the individual or driver attempting to initiate the journey.

51. A monitoring system according to claim 50 further comprising a comparison algorithm for comparing one or more characteristics of a captured image of the individual or driver with the database of biometric data.

52. A monitoring system according to claim 50, wherein at least one of the one or more image capture devices is configured, in use, to capture an image of one or more passengers within the vehicle.

53. A monitoring system according to claim 52, wherein the system is configured to suppress or mask part of the data relating to the one or more passengers.

54. A monitoring system according to claim 50, wherein at least one of the one or more image capture devices is configured, in use, to capture one or more images of an area surrounding the vehicle.

55. A monitoring system according to claim 50, wherein the system is configured to capture and store video data from at least one of the one or more image capture devices in a volatile memory in a circular buffer.

56. A monitoring system according to claim 44, wherein the journey detection module is operatively connected to one or more sensors or to an onboard system of the vehicle to detect movement of the vehicle or an operational state of an engine of the vehicle.

57. A monitoring system for determining compliance with one or more vehicle insurance rules, the system comprising:
a biometric data detection module associated with a vehicle for detecting biometric data associated with an individual operating or driving the vehicle;
a memory on which is stored a database of biometric data associated with one or more authorized individuals;
one or more condition detection sensors for detecting or capturing data relating to driver behaviour; and
a processor operatively connected to the biometric data detection module, the memory and the one or more condition detection sensors;
wherein the system is configured to compare, in use, biometric data detected by the biometric data detection module with the database of biometric data in order to identify an authorized individual corresponding to the detected biometric data, and to associate data from or captured by the one or more condition detection sensors with the identified authorized individual.

58. A monitoring system according to claim 57, wherein the one or more condition detection sensors are configured to detect or capture data relating to one or more of acceleration or deceleration data, geospatial position data, image or video data relating to a surrounding area of the vehicle or to one or more individuals within the vehicle, speed data, tire pressure, status of lights and/or indicators of the vehicle, oil level, engine or brake warning messages.

59. A monitoring system according to claim 57, wherein the system is configured to compile a driver profile associated with the identified authorized individuals, the driver profile comprising the captured driver behavior data.

60. A method of monitoring the use of a vehicle, the method comprising:
detecting an attempt by an individual or driver to initiate a journey;
detecting biometric data associated with the individual or driver attempting to initiate the journey;
comparing the detected biometric data with a database of biometric data associated with one or more authorized individuals to determine whether the individual or driver attempting to initiate the journey is an authorized individual; and
alerting an authority if the detected biometric data does not correspond to the biometric data of one of the one or more authorized individuals.

61. A method according to claim 60 further comprising authorizing the journey if the detected biometric data corresponds to the biometric data of an authorized individual or if an authorization is received from the authority.

62. A method according to claim 61 further comprising comparing a received message with an authorization profile to determine whether the message comprises an authorization from the authority.

63. A method of monitoring compliance with one or more vehicle insurance rules, the method comprising:
detecting biometric data associated with an individual operating or driving the vehicle;
comparing the detected biometric data with the database of biometric data in order to identify an authorized individual corresponding to the detected biometric data;
capturing data relating to driver behavior; and
associating the captured data with the identified authorized individual.
